(19) United States
(12) Patent Application Publication
(10) Pub. No.: US 2008/0230113 A1
(43) Pub. Date: Sep. 25, 2008

(54) LIGHTING SYSTEM

(75) Inventors: Mahendra Dassanayake, Bloomfield Hills, MI (US); Donald Bilger, Livonia, MI (US); Tyler Blake, Rancho Santa Margarita, CA (US); Chad Clement, Belleville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/688,337

(22) Filed: Mar. 20, 2007

(51) Int. Cl. H02N 6/00

(52) U.S. Cl. 136/252; 136/243; 362/487

(57) ABSTRACT

A lighting system is described herein that may be energized by a plurality of sources. In one embodiment, a solar cell is capable of receiving light and converting the light into electrical signals. An energy conversion device may be included that converts movement of the energy conversion device into electrical signals. Additionally, an energy storage device receives and stores the electrical signals from the solar cell and the energy conversion device. The energy storage device is also adapted to supply energy to a lamp that emits light.

### TECHNICAL FIELD

The embodiments described herein relate to a lighting system.

### BACKGROUND OF THE INVENTION

Conventional lighting systems for vehicles include a lighting device, such as a light bulb that is powered by a power source (e.g., a battery). In some systems, along with a battery, solar cells are integrated with vehicles to serve as a power source for the lighting system. These solar cells are typically mounted on exterior portions of the vehicle. Although the conventional lighting systems having batteries and solar cells are useful, there exists a wide horizon for improvement. For example, it is commonly known that solar cells may occupy an undesirable amount of packaging space on a vehicle that interferes with other vehicle accessories such as the placement of a vehicle sunroof. Additionally, with conventional vehicles that utilize solar cells and batteries, the utilization of energy from these various sources is inefficient.

The embodiments described herein were conceived in view of these and other disadvantages of conventional lighting systems.

### SUMMARY OF THE INVENTION

A lighting system is described herein that includes a solar cell being capable of receiving light and converting the light into electrical signals. An energy conversion device may be included that converts movement of the energy conversion device into electrical signals. Additionally, an energy storage device receives the electrical signals from the solar cell and the energy conversion device. The energy storage device is also adapted to supply energy. Accordingly, a lamp that emits light may be coupled to and energized by the energy storage device.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a vehicle having a lighting system in accordance with an embodiment of the present invention;

FIG. 2 illustrates a block diagram of a lighting system in accordance with an embodiment of the present invention;

FIG. 3 illustrates an energy conversion device that is operable with the lighting systems of FIGS. 1 and 2; and

FIG. 4 illustrates an enlarged view of a lamp in accordance with an embodiment of the present invention.

### DETAILED DESCRIPTION OF THE PREFERRED EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

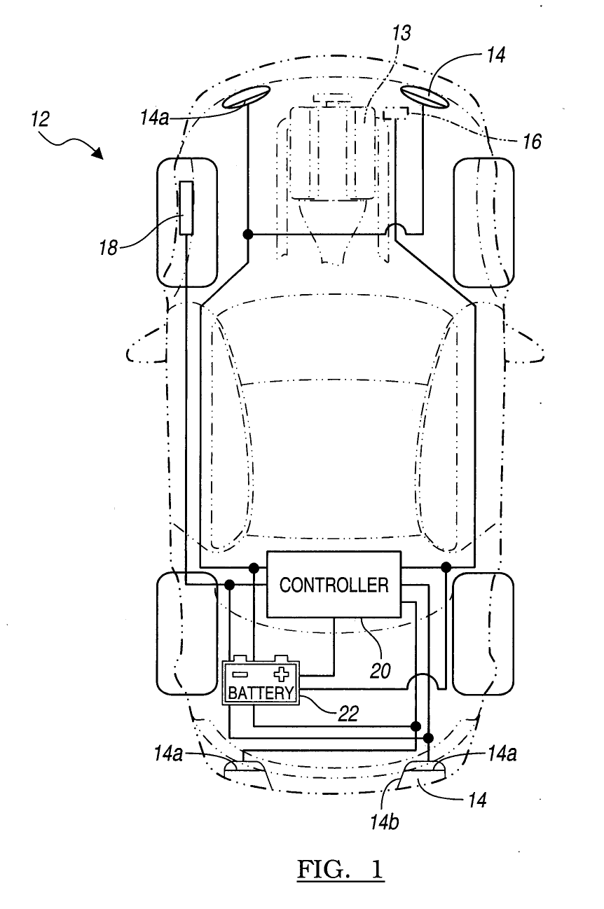

Referring to FIG. 1, a vehicle 12 is shown having a lighting system that is adapted to utilize energy from a plurality of sources in an efficient manner. For example, vehicle 12 may include a lighting system that is energized by a solar cell, a vehicle power supply, and/or a device adapted to convert kinetic energy into electrical signals. It is recognized that although the embodiments herein are described with reference to a vehicle, the present invention may be utilized in non-vehicular applications.

As shown, vehicle 12 includes an engine 13, a power supply device 16, an energy storage device 22 and a plurality of lamps 14. As recognized by one of ordinary skill in the art, engine 13 is adapted to provide motive force to vehicle 12. Additionally, device 16, which may be an alternator, is adapted to provide electrical signals for storage by an energy storage device 22.

Lamps 14 emit light through the use of a light source when energized. In one embodiment, the light source includes a light emitting diode. Lamps 14 also includes a light absorbing surface or solar cell 14a that aligns portions of a lamp housing 14b. The solar cell 14a receives light from a variety of sources for conversion into electricity. Solar cell 14a may receive light from sources that include, but are not limited to, ambient light provided by celestial objects (e.g., the sun, moon, etc.), vehicles, street lamps and the like. Solar cell 14a may be formed of an organic photo cell material or be embodied as a polymeric photovoltaic diode.

FIG. 4 illustrates an enlarged view of lamp 14. As described in the foregoing, lamp 14 includes a light absorbing surface (e.g., a solar cell) 14a that aligns an inner portion 14c. In one embodiment, the solar cell is substantially planar and aligns each surface of inner portion 14c. In this manner, solar cell 14a is efficiently packaged so as to not interfere with other vehicle accessories while maximizing the receipt of light by lamp 14. Upon the receipt of light, solar cell 14a converts the light into electrical signals, which are transmitted to energy storage device 22 for storage.

Energy storage device 22 may be a battery, ultra-capacitor and the like. As such, energy storage device 22 is configured to store a charge and supply power to lamps 14. It is recognized that the placement or location of energy storage device 22 may be virtually any location on a vehicle depending upon the particular implementation of the present invention.

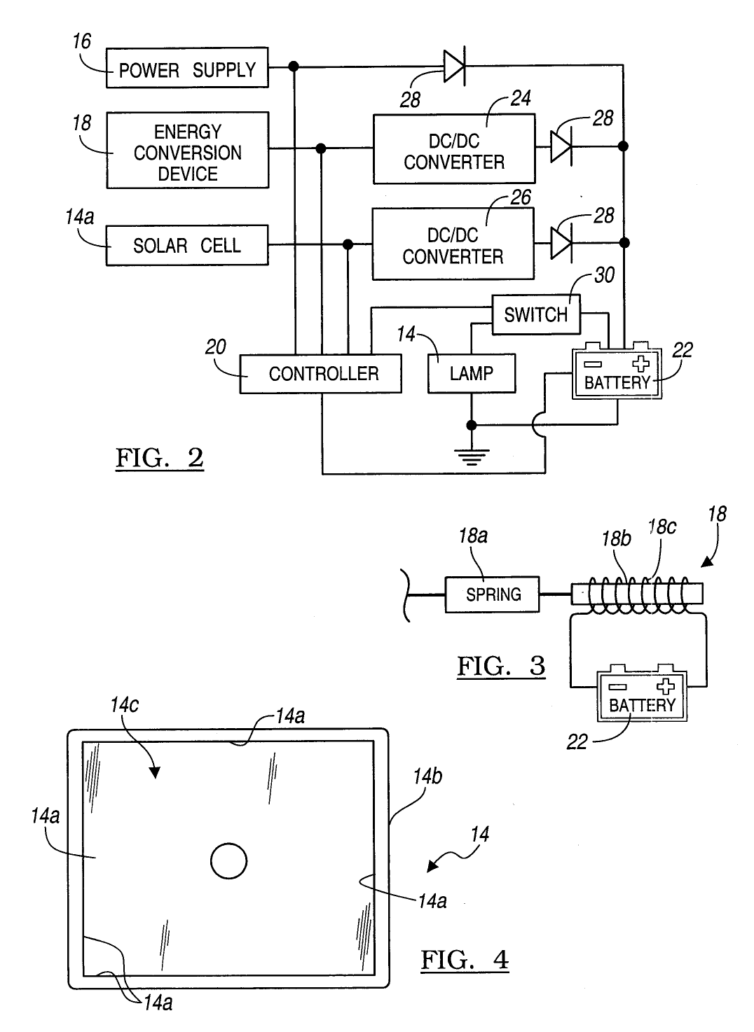

Referring back to FIGS. 1 and 2, vehicle 12 (FIG. 1) also includes an energy conversion device 18. Energy conversion device 18 is adapted to convert movement of the energy conversion device into electrical signals. Particularly, energy conversion device 18 may convert kinetic energy into electrical signals. In one embodiment, although not necessarily, energy conversion device 18 may be located in or near a vehicle suspension component or a wheel well of the vehicle. FIG. 3 provides a detailed illustration of one embodiment of energy conversion device 18.

As shown, energy conversion device 18 may include a spring 18a, a magnet 18b, and a coil 18c. One end of spring 18 a may be securely fastened to vehicle 22 while a second end is coupled to magnet 18b. As vehicle 12 moves, spring 18a enables magnet 18b to traverse the inner portions of coil 18c. Based on electromagnetic principles commonly known to those of ordinary skill in the art, the movement of magnet 18b within coil 18c causes an electrical signal to be generated, which is received and stored by energy storage device 22. Spring 18a also serves as a restoring spring, thereby enabling magnet 18b to return to a predetermined position when vehicle 12 is stationary.

Vehicle 12 also includes a controller 20. Controller 20 is adapted to assess and determine the charging power of power supply device 16, energy conversion device 18, and solar cell 14a. Based on signals received by power supply device 16, energy conversion device 18 and solar cell 14a, controller 20 is also adapted to generate control signals for a switch 30 (FIG. 2) to couple lamp 14 to energy storage device 22. Switch 30 may be a network of transistors or a discrete switch.

As shown in FIG. 2, the lighting system may include one or more direct-current to direct-current (DC/DC) converters 24 and 26. Converters 24 and 26 upwardly convert the voltages of signals received from energy conversion device 18 and solar cell 14a for storage by energy storage device 22. In the illustrated embodiment, as shown, a plurality of diodes 28 may be included so as to enable the flow of electrical signals in a desired direction (i.e., towards energy storage device 22 for storage). As energy storage device 22 is charged, switch 30 may receive a control signal to couple lamp 14 to energy storage device 22, thereby enabling the emission of light by lamp 14.

While the best mode for carrying out the invention has been described in detail, those familiar with the art to which this invention relates will recognize various alternative designs and embodiments for practicing the invention as defined by the following claims.

What is claimed:

1. A lighting system comprising:
a solar cell receiving light and converting the light into electrical signals;
an energy conversion device converting movement of the energy conversion device into electrical signals;
an energy storage device for receiving the electrical signals from the solar cell and the energy conversion device, the energy storage device being adapted to supply energy; and
a lamp that emits light, the lamp being coupled to and energized by the energy storage device.

2. The system of claim 1, further comprising:
a switch device that couples the energy storage device to the lamp; and
a controller being in communication with the switch device, the solar cell, the energy conversion device and the energy storage device, the controller determining the availability of electrical signals from the solar cell and the energy conversion device, and generating control signals for the switch device to couple the energy storage device to the lamp.

3. The system of claim 2, further comprising at least one DC/DC converter that receives electrical signals from at least one of the solar cell and the energy conversion device and communicates with the energy storage device, the DC/DC converter increasing the voltage of the electrical signals for storage by the energy storage device.

4. The system of claim 2, wherein the solar cell is integrated with the lamp.

5. The system of claim 4, wherein the solar cell being integrated with the lamp includes the solar cell being substantially planar and aligning an inner portion of a lamp housing.

6. The system of claim 2, further comprising a power supply that communicates with the energy storage device for charging the energy storage device; and
wherein the controller determines the ability of the power supply to charge the energy storage device.

7. The system of claim 1, wherein the lamp includes a light emitting diode (LED).

8. A lighting device comprising:
a housing containing a light absorbing surface, the light absorbing surface converting light into electrical signals for storage by an energy storage device; and
a light source being coupled to the energy source and emitting light.

9. The device of claim 8, wherein the light source includes a light emitting diode (LED).

10. The device of claim 9, wherein the light absorbing surface includes an organic photovoltaic cell material.

11. The device of claim 11, wherein the light absorbing surface is substantially planar and aligns an inner portion of the housing.

12. A lighting system for a vehicle, the system comprising:
an energy conversion device mounted on the vehicle for converting movement of the energy conversion device into electrical signals;
an energy storage device for receiving and storing the electrical signals from the solar cell and the energy conversion device, the energy storage device being adapted to supply energy;
a lamp mounted on the vehicle having a solar cell integrated therewith, the solar cell receiving light and converting the light into electrical signals for storage by the energy storage device, the lamp being coupled to and energized by the energy storage device to emit light;
a switch device that couples the energy storage device to the lamp; and
a controller being in communication with the switch device, the solar cell, the energy conversion device and the energy storage device, the controller determining the availability of electrical signals from the solar cell and the energy conversion device and generating control signals for the switch device to couple the energy storage device to the lamp.

13. The system of claim 12, further comprising at least one DC/DC converter that receives electrical signals from at least one of the solar cell and the energy conversion device and communicates with the energy storage device, the DC/DC converter increasing the voltage of the electrical signals for storage by the energy storage device.

14. The system of claim 12, wherein the solar cell is integrated with the lamp.

15. The system of claim 14, wherein the solar cell being integrated with the lamp includes the solar cell being substantially planar and aligning an inner portion of a lamp housing.

16. The system of claim 15, wherein the solar cell being substantially planar and aligning the inner portion of the lamp housing includes the substantially planar solar cell aligning each surface of the lamp housing.

17. The system of claim 16, wherein the solar cell includes a solar cell having a polymeric photovoltaic diode.

18. The system of claim 12, further comprising a power supply that communicates with the energy storage device for charging the energy storage device; and
wherein the controller determines the ability of the power supply to charge the energy storage device.

19. The system of claim 18, wherein the power supply includes an alternator being mounted on the vehicle.

20. The system of claim 12, wherein the lamp includes a light emitting diode (LED).
